(19) United States
(12) Patent Application Publication
(10) Pub. No.: US 2026/0144186 A1
(43) Pub. Date: May 28, 2026

(54) ROTARY CUTTING BLADE

(71) Applicant: Briggs & Stratton, LLC, Wauwatosa, WI (US)

(72) Inventors: Bryce Metcalf, New Berlin, WI (US); Andrew Joestgen, Waukesha, WI (US); James Marshall, Munnsville, NY (US)

(21) Appl. No.: 19/120,583

(22) PCT Filed: Oct. 20, 2023
(86) PCT No.: PCT/US2023/077488

§ 371 Date: Apr. 11, 2025

Related U.S. Application Data
(60) Provisional application No. 63/417,813, filed on Oct. 20, 2022.

(51) Int. Cl. A01D 34/73; A01D 101/00

(52) U.S. Cl. CPC A01D 34/73; A01D 2101/00

(57) ABSTRACT

A rotary cutting blade includes a cutting edge, a lift wing that arcs or angles upwardly from the cutting edge and defines a leading end from which the cutting edge extends and a trailing end, and a wing tail that extends from the trailing end of the lift wing in a direction away from the cutting edge.

### CROSS-REFERENCE TO RELATED PATENT APPLICATIONS

This application claims the benefit of and priority to U.S. Provisional Application No. 63/417,813, filed on Oct. 20, 2022, the entire disclosure of which is hereby incorporated by reference herein.

### BACKGROUND

Mowers typically include a cutting blade that is rotated to cut material (e.g., grass).

### SUMMARY

At least one embodiment relates to a rotary cutting blade for a lawn mower. The rotary cutting blade includes a cutting edge, a lift wing that arcs or angles upwardly from the cutting edge and defines a leading end from which the cutting edge extends and a trailing end, and a wing tail that extends from the trailing end of the lift wing in a direction away from the cutting edge.

Another embodiment relates to a rotary cutting blade for a lawn mower. The rotary cutting blade includes a body having a cutting edge that defines a cutting plane, a lift wing, and a wing tail. A cross-sectional profile of the body taken along a direction parallel to a cutting direction and through the wing tail includes a cutting portion that extends in a direction parallel to the cutting plane, a lift wing portion that angles or arcs upwardly away from the cutting plane, and a tail portion that extends along the wing tail from a trailing end of the lift wing in a direction away from the cutting edge at an angle that is approximately parallel to the cutting plane.

Another embodiment relates to a rotary cutting blade for a lawn mower. The rotary cutting blade includes a body having a cutting edge, a lift wing, and a wing tail that extends from a trailing end of the lift wing in a direction away from the cutting edge. The lift wing is arranged between the cutting edge and the wing tail. The lift wing defines an inflection point along the body where the body transitions from concave up to concave down.

Another embodiment relates to a rotary cutting blade for a lawn mower. The rotary cutting blade includes a body including a cutting edge, a lift wing that arcs or angles upwardly away from the cutting edge, and a wing tail that extends from a trailing end of the lift wing in a direction away from the cutting edge. The wing tail extends axially along the body a tail distance. A ratio between a radius defined by the body and the tail distance is between about 10.5 and about 2.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements

### BRIEF DESCRIPTION OF THE FIGURES

The disclosure will become more fully understood from the following detailed description, taken in conjunction with the accompanying figures, where like reference numerals refer to like elements, in which:

FIG. 1 is a perspective view of a mower, according to some embodiments;

FIG. 2 is a block diagram of the mower of FIG. 1;

FIG. 3A is a top view of a cutting blade, according to some embodiments;

FIG. 3B is a top view of the cutting blade of FIG. 3A in a reverse orientation;

FIG. 4A is a side view of the cutting blade of FIG. 3A;

FIG. 4B is a side view of the cutting blade of FIG. 3A with a reduced wing height;

FIG. 4C is a side view of the cutting blade of FIG. 3A with a further reduced wing height;

FIG. 5 is a top, side view of the cutting blade of FIG. 3A;

FIG. 6 is a top view of a wing tail portion of the cutting blade of FIG. 3A;

FIG. 7 is a top perspective view of the wing tail portion of FIG. 6;

FIG. 8 is a side view of the cutting blade of FIG. 3A including a non-tapered wing tail;

FIG. 9 is a top perspective of a rotary cutting blade of FIG. 3A including a tapered recess;

FIG. 10 is a top view of the rotary cutting blade of FIG. 9;

FIG. 11 is a side view of the rotary cutting blade of FIG. 9;

FIG. 12 is an enlarged view of a wing tail portion of the rotary cutting blade of FIG. 11;

FIG. 13 is a flow visualization of a cross section of the cutting blade of FIG. 8;

FIG. 14A is a flow visualization of a cross section of a conventional cutting blade at a first moment in time;

FIG. 14B is a flow visualization of a cross section of a conventional cutting blade at a second moment in time;

FIG. 14C is a flow visualization of a cross section of a conventional cutting blade at a first moment in time;

FIG. 15 is a flow visualization of a cross section of a cutting blade with a sharpened wing tail portion at a first moment in time;

FIG. 16 is a flow visualization of a cross section of a cutting blade with a sharpened wing tail portion at a second moment in time;

FIG. 17 is a flow visualization of a cross section of a cutting blade with a sharpened wing tail portion at a third moment in time;

FIG. 18A is a flow visualization at a first moment in time of a cross section of a cutting blade with a wing tail portion having a flattened trailing edge; and

FIG. 18B is a flow visualization at a second moment in time of a cross section of a cutting blade with a wing tail portion having a flattened trailing edge.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

The use herein of the term “axial” and variations thereof refers to a direction that extends generally along an axis of symmetry, a central axis, or an elongate direction of a particular component or system. For example, an axially-extending structure of a component may extend generally along a direction that is parallel to an axis of symmetry or an elongate direction of that component. Similarly, the use herein of the term “radial” and variations thereof refers to directions that are generally perpendicular to a corresponding axial direction. For example, a radially extending structure of a component may generally extend at least partly along a direction that is perpendicular to a longitudinal or central axis of that component. The use herein of the term “circumferential” and variations thereof refers to a direction that extends generally around a circumference or periphery of an object, around an axis of symmetry, around a central axis, or around an elongate direction of a particular component or system.

In general, mowers (e.g., lawn mowers) utilize one or more cutting blades to cut material (e.g., grass) and the mower moves along a travel path. Current trends for lawn mowers are adding electrification (e.g., batteries and/or battery packs) to replace or supplement the power provided by an internal combustion engine. In some configurations, a cutting blade is coupled to an electric motor that is powered by a battery and configured to rotate the cutting blade at a predetermined speed. As a cutting blade is rotated, it experiences drag forces due to the ambient air flowing over the surfaces of the cutting blade. The shape and design of a cutting blade may influence the drag characteristics and, correspondingly, the amount of power input required to rotate the cutting blade at a particular speed. Conventional cutting blade designs typically include a lift wing that defines an angled or arcuate profile behind a cutting edge. The lift wing aids in generating a lifting force to move cut material out of the cutting path and direct it toward an outlet, but the lift wing also introduces drag forces and may generate turbulence behind the cutting blade. Accordingly, there is typically a trade-off between lifting performance and input power requirements (i.e., drag) in conventional cutting blades on a lawn mower.

The systems and methods described herein provide a cutting blade for a lawn mower that overcomes the deficiencies of conventional cutting blades by incorporating an aerodynamically-efficient design that maintains cut quality and lifting forces, while significantly reducing the input power required to rotate the cutting blade (e.g., when compared to the input power required to rotate a conventional cutting blade at the same rotational speed). In some embodiments, a cutting blade includes a cutting edge that defines a cutting plane, a lift wing, and a wing tail, or protrusion, that extends from a trailing end of the lift wing in a direction away from the cutting edge. In general, the wing tail defines an extension from the trailing end of the lift wing that provides an aerodynamically-efficient design to the cutting blade. For example, the inclusion of the wing tail reduces or eliminates turbulence, or eddies, forming along a trailing side of the cutting blade. This maintains laminar flow along the surfaces of the cutting blade to reduce drag, and the corresponding input power required to rotate the cutting blade, and maintains the lifting force and cut quality of the cutting blade. As such, the incorporation of the wing tail into the cutting blade provides a cutting blade that reduces a power requirement of a lawn mower (e.g., provided to an electric motor that rotates the cutting blade), while maintaining or improving cut quality and lifting force.

In some embodiments, a cross-sectional profile of a body of the cutting blade taken along a direction parallel to a cutting direction (or normal to a cutting edge) and through the wing tail includes a cutting portion that extends in a direction parallel to the cutting plane, a lift wing portion that angles or arcs upwardly away from the cutting plane, and a tail portion that extends along the wing tail from a trailing end of the lift wing in a direction away from the cutting edge at an angle that is approximately parallel to the cutting plane. In some embodiments, the angle that the wing tail extends from the trailing end of the lift wing is between about plus or minus 45 degrees relative to the cutting plane, or between about plus or minus 40 degrees relative to the cutting plane, or between about plus or minus about 35 degrees relative to the cutting plane, or between about plus or minus about 30 degrees relative to the cutting plane, or between about plus or minus about 25 degrees relative to the cutting plane, or between about plus or minus about 20 degrees relative to the cutting plane, or between about plus or minus about 15 degrees relative to the cutting plane, or between about plus or minus about 10 degrees relative to the cutting plane, or between about plus or minus about 5 degrees relative to the cutting plane.

In some embodiments, a cross-sectional profile a body of the cutting blade taken along a direction parallel to a cutting direction and through the wing tail includes an inflection point between a cutting portion and a wing tail portion. For example, the lift wing is arranged between the cutting edge and the wing tail and the lift wing defines the inflection point where a profile of the lift wing transitions from concave up to concave down (e.g., a line extending along a boundary or a centerline of the lift wing includes an inflection point). In some embodiments, the lift wing portion defines an inflection point where a profile of the lift wing portion transitions from concave up to concave down (e.g., a line extending along a boundary or a centerline of the lift wing portion includes an inflection point). In some embodiments, the lift wing defines an inflection point along the body where the body transitions from concave up to concave down (e.g., a line extending along a boundary or a centerline of the body includes an inflection point).

In some embodiments, the wing tail extends axially along a body of the cutting blade a tail distance. In some embodiments, a ratio between a radius defined by a body of the cutting blade and the tail distance is between about 21 and about 1.5, or between about 10.5 and about 1.5, or between about 7 and about 1.5, or between about 10.5 and about 2, or between about 7 and about 2, or between about 6 and about 2, or between about 6 and about 3, or between about 4.5 and about 3, or between about 4.5 and about 3.5.

### Mower

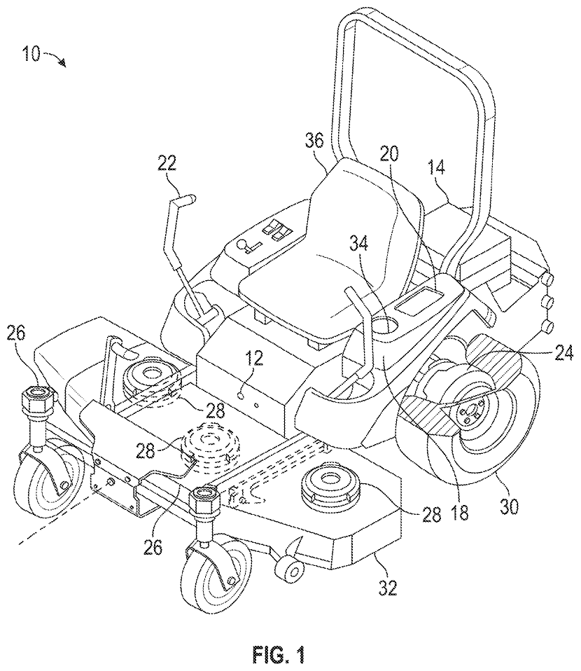

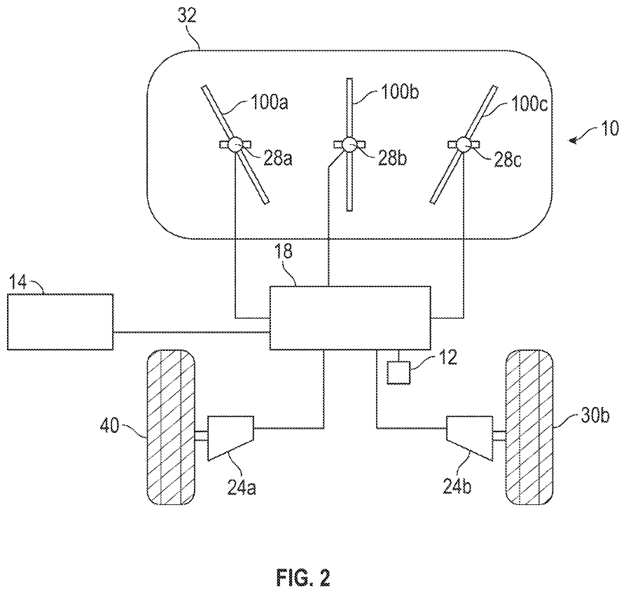

Referring to FIG. 1, outdoor power equipment (e.g., stand-on mower, lawn tractor, walk-behind mower, all-terrain vehicle, loader, thatcher, edge trimmer, seeder, sprayer, snow thrower, sod cutter, power rake, overseeder, aerator, sod cutter, brush mower, spreader, golf cart, etc.) is shown as mower 10. As shown, mower 10 is a ride-on mower. In some embodiments, the mower 10 is a zero turn radius (ZTR) mower. In some embodiments, the mower 10 is a walk-behind mower. While the outdoor power equipment is shown as mower 10, it is contemplated that the outdoor power equipment can also be operated as other lawn care devices, such as those listed above.

In some embodiments, the mower 10 includes a number of sensors 12 (e.g., vision sensors, camera sensors, IR transmitters, IR cameras, thermal cameras, position sensors, accelerometers, inductive sensors, etc.), one or more batteries, shown as battery pack 14, a controller 18, one or more user interfaces 20, and one or more input devices 22.

In some embodiments, the sensors 12 on the mower 10 may be positioned around the mower 10 as shown, as well as in other locations as needed for a given configuration. The sensors 12 may be all of the same type, or may be a combination of different sensor types. Sensors may include moisture sensors, rain sensors, air quality sensors, magnetic field sensors (e.g. compass), temperature sensors, digital imaging sensors, motion detection sensors, rotation sensors, gyroscopes, chemical detection sensors, and the like.

In some embodiments, the mower 10 may further include a number of electric motors. In some embodiments, the motors are brushless DC motors. In other embodiments, the motors are one or a combination of brushed DC motors, AC motors, permanent magnet motors, etc. The mower 10 may have one or more traction motors 24, one or more hub motors 26, and/or one or more implement motors 28. In some embodiments, the mower 10 may have a traction motor 24 for each of the rear drive wheels 30. In further embodiments, the mower 10 may have a hub motor 26 for each non-traction wheel (e.g., hub or castor wheels), as shown in FIG. 1. The hub motors 26 may allow for the non-traction wheels to be positioned or locked into position when operating the mower 10 in certain modes.

In some embodiments, the mower 10 may have one or more implement motors 28. The implement motors may be used to drive one or more attachments associated with the mower 10. In some embodiments, the implement motors 28 may each drive a cutting implement, such as a rotary cutting device (e.g., blade, rotating blade, spinning blade, etc.), shown as mower blade 100. However, in other examples, the implement motors 28 may be used to drive other attachments such as spreaders, blowers, power rakes, or other applicable attachments. In some embodiments, the attachment motors are located on a mowing deck 32. The mowing deck 32 may house the implement motors 28 and one or more cutting blades attached to each of the attachment motors. In some embodiments, the implement motors 28 may be connected via a central bus. The central bus may provide power and communications to and from other devices, such as the controller 18 and/or the battery pack 14. In some embodiments, the central bus may allow for a single connection from the mowing deck 32 to the body of the mower 10. The computing power used for the mower 10 may be distributed across all controllers 18 and controller modules. In addition, different controllers or controller modules receive and transmit data with each other to make decisions and perform actions such that decentralized information processing takes place across the controllers 18.

The mowing deck 32 may include one or more inserts to reduce sound emissions. The inserts may be made of one or a combination of materials to deaden the sounds produced by the attachments on the mowing deck 32, including the implement motors 28. For example, the inserts may be made of one or a combination of various types of foam, rubber, Styrofoam, gels, etc. The mowing deck may further have one or more attachment rails to allow for other attachments to easily be added to the mower 10. In some embodiments, the attachment rail may be configured to include power and/or data connections, which may provide power to the additional attachments and/or communications to components on the mower 10, such as the controller 18. Example attachments may include blowers, vacuums, baggers, and the like.

In further embodiments, the mowing deck 32 may also have additional implement motors 28 for controlling other aspects of the mowing deck 32, such as the storage mode actuators, mowing deck 32 height adjustment devices, multi-directional discharge chute controls, etc. In some embodiments, the mower 10 may additionally have implement motors 28, such as seat adjustment motors, suspension control motors, etc.

In some embodiments, the mower 10 may include other features such as cup holders 34, adjustable seat 36, etc. In some embodiments, the cup holders 34 may be powered via the battery pack 14 and contain heating and/or cooling elements to allow for items placed in the cup holders 34 to be heated or cooled, respectively. In some embodiments, the adjustable seat 36 may be coupled to the battery pack 14 and configured to be adjusted via one or more electronic positioning devices. In still further embodiments, the adjustable seat 36 may include one or more heating or cooling elements, powered by the battery pack 14, to provide for operator comfort.

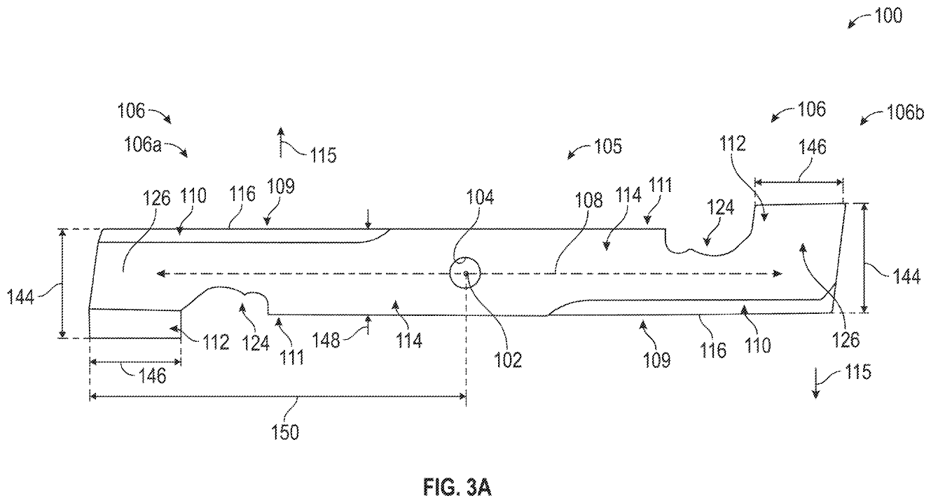

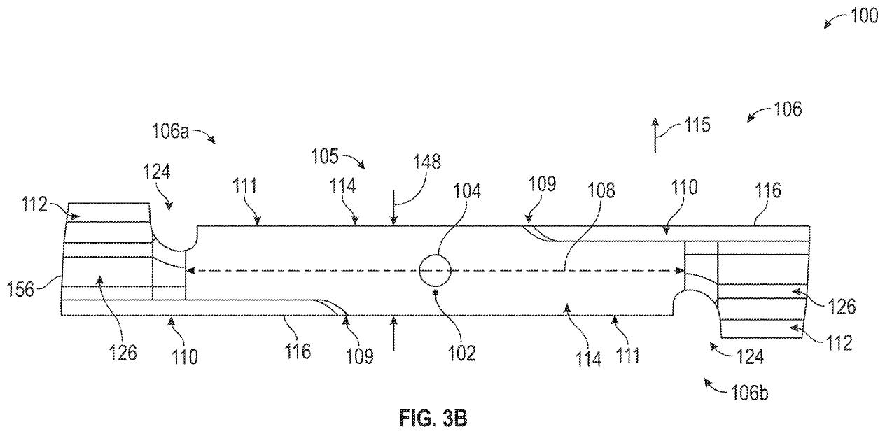

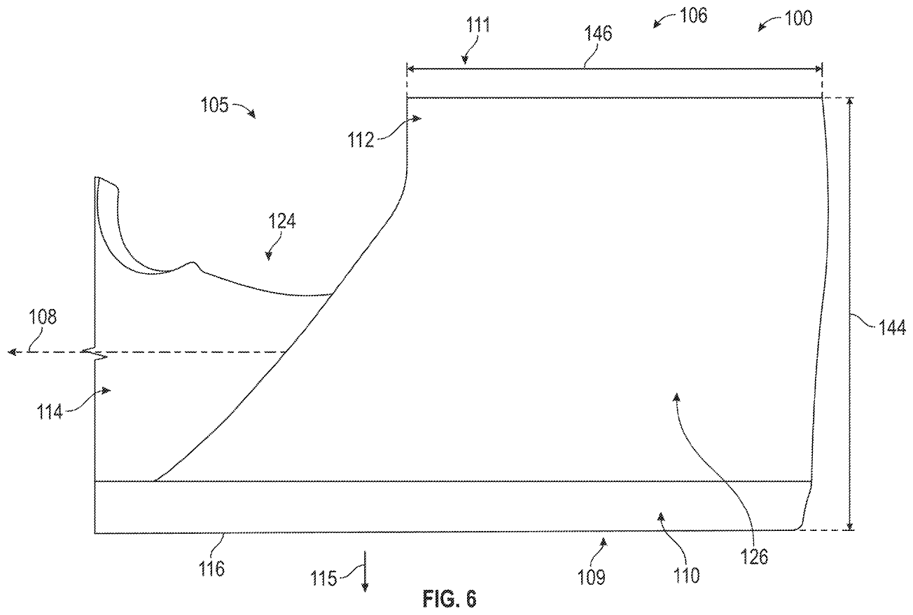

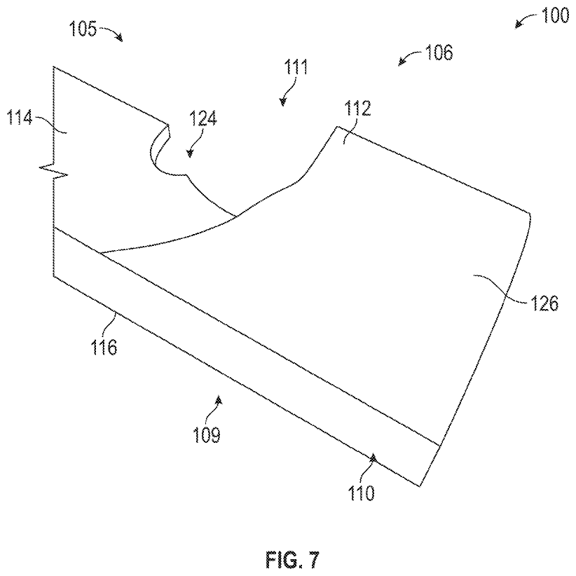

In some embodiments, the battery pack 14 is a rechargeable battery (e.g., rechargeable battery, rechargeable battery bank, rechargeable battery array, rechargeable energy storage device, etc.), according to some embodiments. In some embodiments, the battery pack 14 may be a rechargeable battery, such as a Li-ion battery. However, other battery types, such as NiCd, lead-acid, Nickel-Metal Hydride (NiMH), or Lithium Polymer, are also contemplated. The battery pack 14 may be a lithium-ion battery comprising multiple Li-ion cells arranged in a variety of series(S) and parallel (P) configurations. In some embodiments, the battery pack 14 provides about one kilowatt-hour of energy (e.g., between 800 watt-hours and 2 kilowatt-hours). In some embodiments, the battery pack 14 is configured to be small enough, light enough, and graspable enough to allow the battery pack 14 to be manually portable by the user. In other embodiments, the battery pack 14 is not configured to be small enough, light enough, and graspable enough to allow the battery pack 14 to be manually portable by the user. For example, a user may need a lift, hoist, or other carrying device to move the battery pack 14. In some embodiments, end products powered by the battery pack 14 generally scale in increments that can be measured in kilowatt-hours of energy. For example, a standard residential lawn tractor may require between two and three kilowatt-hours of energy capacity, and a premium residential lawn tractor may require between three and four kilowatt-hours of energy capacity. The battery pack 14 may be interchangeable between different pieces of equipment (e.g., between a lawn tractor, a vehicle, a backup power supply, a stand-alone power supply, a portable generator, a trolling motor, a golf cart, etc.). In some embodiments, the battery pack 14 is configured to be removed without the use of tools. For example, the battery pack 14 may be removably coupled to the mower 10 by one or more latches, straps, detents, magnets, electrical coupler, etc., or any combination thereof. Referring to FIGS. 3A-7, a rotary cutting blade or mower blade 100 is configured to be selectively rotated about an axis, shown as pivot axis 102. In some embodiments, the mower blade 100 is included in the mower 10 (e.g., mower blade 100a, mower blade 100b, mower blade 100c) of the mower 10. In some embodiments, the mower blade 100 is coupled to a shaft of an electric motor (e.g., one of the implement motors 28).

The mower blade 100 may include one or more mounting features (e.g., holes, apertures, threading, threaded holes, channels, grooves, etc.), shown as pivot aperture 104, to which a corresponding feature of the electric motor may engage in order to couple the mower blade 100 to a mower (e.g., the mower 10). In some embodiments, the mower blade 100 includes a body 105 having one or more arms 106, shown as arm 106a and arm 106b extending from axially-opposing sides of the pivot aperture 104 (see, e.g., FIG. 3A). The arm 106a and the arm 106b include the similar design, properties, and features, with similar features identified using like reference numerals, in order to balance the mower blade 100 about the pivot axis 102 (e.g., the mower blade 100 is rotationally symmetric about the pivot axis 102).

In some embodiments, the body 105 of the mower blade 100 is a unitary body (e.g., a solid body, a monolithic structure, etc.), and/or the arms 106 are in a fixed position relative to the pivot axis 102. For example, the mower blade 100 may be formed via a stamping process (e.g., formed from a blank of metal), a forging or casting process (e.g., poured into a mold and subsequently hardened in the shape of the mold), an additive manufacturing process (e.g., 3-D printing, metal printing, etc.), or a subtractive manufacturing process (e.g., a machining process, milling, cutting, carving, etc.). The mower blade 100 may be made at least partially of a metal (e.g., steel, tempered steel, martensitic steel, high carbon steel, stainless steel, etc.), a metal alloy, ceramic, polymer, composite, or combinations thereof. In some embodiments, the mower blade 100 is made of hardened steel (e.g., work hardened steel, tempered steel, steel exceeding 38 Rockwell). In some embodiments, one or more portions of the mower blade 100 are formed separately and then combined (e.g., welded together, fused together, coupled together, assembled, etc.) into a mower blade 100.

The body 105 of the mower blade 100 defines a longitudinal axis 108 that intersects the pivot axis 102 and extends along the axial length of each arm 106a, 106b. In some embodiments, each arm 106 defines a leading or front edge 109 having a cutting portion 110 and a trailing or rear edge 111, which is arranged opposite to the leading edge 109 in a direction perpendicular to the longitudinal axis 108, having a wing tail 112. The cutting portion 110 and wing tail 112 may be axially spaced from the pivot aperture 104 by an arm body portion 114 (see, e.g., FIG. 3A). In some embodiments, the leading edge 109 and the trailing edge 111 extend axially along an entire length of each of the arms 106. In some embodiments, the leading edge 109 of the arm 106a may be on an opposing side of the body 105 relative to the leading edge 109 of the arm 106b, so that as the cutting blade 100 rotates, the leading edges 109 approach and initially contact the material to be cut. In some embodiments, as shown in FIG. 3B, the orientation of the arms 106a, 106b may be rotationally flipped about the longitudinal axis 108 (e.g., the leading edge 109 and the the trailing edge 111of the arms 106a, 106b are flipped about the longitudinal axis 108) to accommodate different rotational cutting directions (e.g., accommodate clockwise rotational input from a chore motor or counterclockwise rotational input from a chore motor). In some embodiments, the trailing edge 111 may include at least a portion of the wing tail 112. In some embodiments, the trailing edge 111 of the arm body portion 114 is blunt or unsharpened. In some embodiments, at least a portion of the trailing edge 111 (e.g., within the wing tail 112 and/or the arm body portion 114) is beveled, chamfered, or tapered.

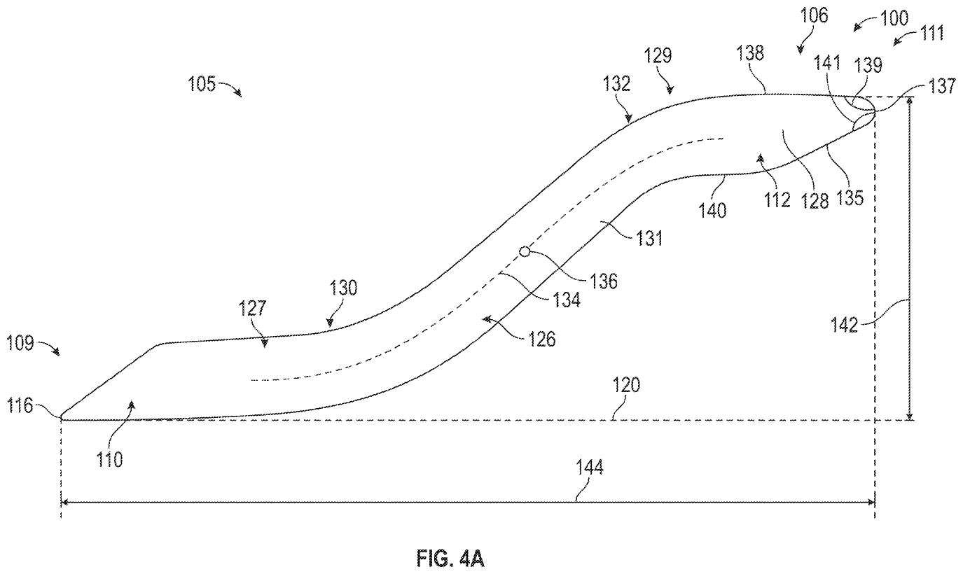

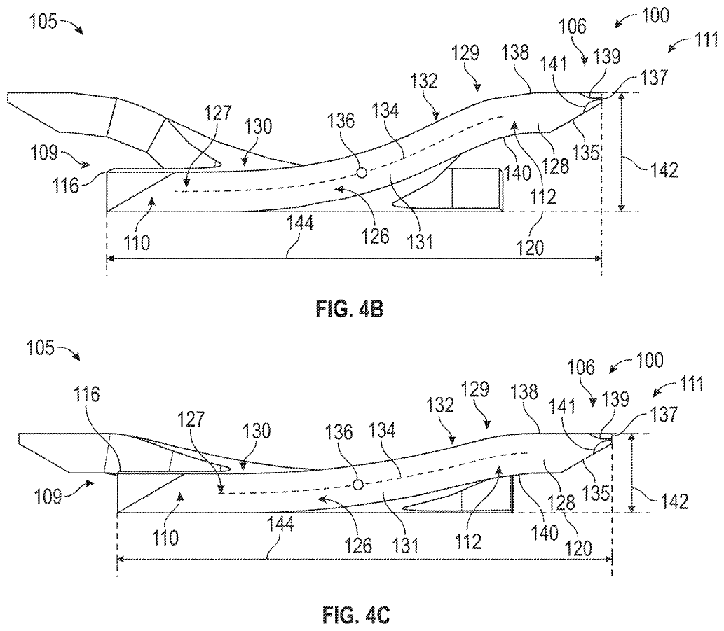

In some embodiments, the cutting portion 110 is arranged adjacent to a distal end of the respective arm 106 and includes a cutting edge 116 that contacts the material to be cut (e.g., grass, brush, corn stalks, wheat, crop, etc.) and is configured to perform a cutting action. The cutting edge 116 defines a cutting plane 120 that extends approximately parallel to a bottom side or surface of the cutting edge 116 (e.g., from the perspective of FIG. 4). In some embodiments, the cutting edge 116 may be or include a single bevel edge (e.g., a chisel edge), a double bevel edge (e.g., a v-edge), a compound bevel edge, a convex edge, a hollow edge, or a combination thereof. For example, an inner portion of the cutting edge 116 (e.g., a portion of the cutting edge 116 proximate the pivot axis 102) may include a double bevel edge, while an outer portion of the cutting edge 116 (e.g., a portion distal the pivot axis 102) may have a single bevel edge. In some embodiments, the cutting edge 116 is a single bevel edge that is angled upward such that air and debris that contact the cutting edge 116 are directed toward the top surface of the mower blade 100.

In some embodiments, the cutting portion 110 extends axially along (e.g., along a direction parallel to the longitudinal axis 108) at least a portion of the leading edge 109 of each of the arms 106a, 106b. In some embodiments, the cutting edge 116 extends along at least half (50%) of the axial length of the leading edge 109 of each of the arms 106a, 106b. In some embodiments, the cutting edge 116 forms at least a portion of the leading edge 109. In some embodiments, the leading edge 109 of the arm body portion 114 is blunt or not sharpened. In other embodiments, the leading edge 109 of the arm body portion 114 includes at least a portion of the cutting edge 116.

The arm body portion 114 may be substantially planar and have an approximately uniform material width (e.g., the body width 148 illustrated in FIG. 3) measured in a plane perpendicular to the longitudinal axis 108 and parallel to a cutting direction 115 (e.g., a direction that is normal to the cutting edge 116). In some embodiments, a recessed portion 124 is arranged axially between the pivot aperture 104 and the wing tail 112 along the trailing edge 111. The recessed portion 124 may have a tapered material thickness and/or a locally divergent surface structure (e.g., bumpy, grooved, raised, recessed, dimpled, etc.). For example, the trailing edge 111 in the recessed portion 124 may taper, arc, and/or slope toward the leading edge 109 so that a width of the arms 106a, 106b in the recessed portion 124, measured in a direction parallel to the cutting direction 115, is less than a maximum thickness defined by the arm body portion 114.

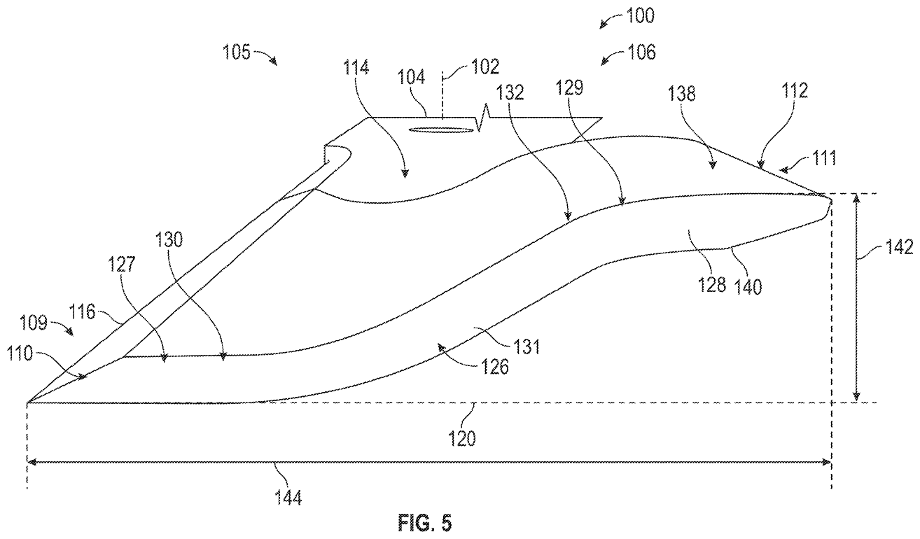

The body 105 includes the wing tail 112 at a distal end of each arm 106. A lift wing 126 is arranged between the cutting edge 116 and the wing tail 112. With specific reference to FIGS. 4 and 5, moving in a direction from the leading edge 109 toward the trailing edge 111, the lift arcs or angles upwardly from the cutting edge 116 in a direction away from the cutting plane 120. The lift wing 126 defines a leading end 127 from which the cutting portion 110 and the cutting edge 116 extend and a trailing end 129. The wing tail 112 extends from the trailing end 129 of the lift wing 126 in a direction away from the cutting edge 116. In general, the arcuate or curved profile defined by the lift wing 126 aids in generating a lifting force as air flows over the frontal area of the lift wing 126. As will be described herein, the inclusion of the wing tail 112 (e.g., a protrusion or extension) that extends from the trailing end 129 of the lift wing 126 significantly reduces the drag on the cutting blade 100 and reduces the input power required to rotate the cutting blade 100, while maintaining cut quality.

In some embodiments, a cross-sectional profile of the body 105 taken along a direction parallel to a cutting direction 115 and through the wing tail 112 includes the cutting portion 110, a tail portion 128, and a lift wing portion 131 arranged between the cutting portion 110 and the tail portion 128. The cutting portion 110 extends in a direction approximately parallel to the cutting plane 120, and the lift wing portion 131 angles or arcs upwardly away from the cutting plane 120. The tail portion 128 extends along the wing tail 112 from the trailing end 129 of the lift wing 126 in a direction away from the cutting edge 116 at an angle that is approximately parallel to the cutting plane 120. For example, a line extending parallel to the cutting direction 115 and tangent to a tail top surface 138 of the wing tail 112 may be arranged approximately parallel to the cutting plane 120.

In some embodiments, the wing tail 112 may be in non-parallel arrangements where the wing tail 112 is at a nonzero angle relative to the cutting plane 120. For example, the wing tail 112 may be angled upwardly or downwardly (e.g., from the perspective of FIGS. 4 and 5) relative to the orientations illustrated in FIGS. 4 and 5. In some embodiments, the angle that the wing tail 112 and the tail portion 128 extend from the trailing end 129 of the lift wing 126 is between about plus or minus 45 degrees relative to the cutting plane 120, or between about plus or minus 40 degrees relative to the cutting plane 120, or between about plus or minus about 35 degrees relative to the cutting plane 120, or between about plus or minus about 30 degrees relative to the cutting plane 120, or between about plus or minus about 25 degrees relative to the cutting plane 120, or between about plus or minus about 20 degrees relative to the cutting plane 120, or between about plus or minus about 15 degrees relative to the cutting plane 120, or between about plus or minus about 10 degrees relative to the cutting plane 120, or between about plus or minus about 5 degrees relative to the cutting plane 120. For example, for non-parallel arrangements of the wing tail 112 relative to the cutting plane 120, the angle formed between the wing tail 112 and the cutting plane 120 may be defined at an intersection between a line, which extends parallel to the cutting direction 115 and tangent to a tail top surface 138 of the wing tail 112, and the cutting plane 120.

In the illustrated embodiment, the cutting edge 116 is a single beveled edge that is beveled to the bottom surface (e.g., from the perspective of FIGS. 4 and 5) of the mower blade 100. The cutting portion 110 leads the lift wing 126 and the wing tail 112 during rotation of the mower blade 100. In general, the incorporation of the wing tail 112 into the body 105 extends the lift wing 126 and changes a curvature defined by the lift wing 126 as the lift wing 126 extends from the leading end 127 to the trailing end 129. For example, the lift wing 126 defines an arcuate profile changes curvature between the cutting portion 110 and the wing tail 112. The change in curvature defines regions having different curvature and a corresponding inflection point 136 arranged between a first portion 130 of the lift wing 126 and a second portion 132 of the lift wing 126. The first portion 130 defines a concave up curvature and the second portion 132, which is arranged closer to the trailing end 129 than the first portion 130, defines a concave down or convex curvature. Accordingly, the lift wing 126 defines an inflection point 136 between the first portion 130 and the second portion 132, where a curvature of the lift wing 126 transitions from concave up to concave down (e.g., convex). The inflection point 136 illustrated in FIG. 4 is defined along an line 134 that extends along a centerline of the lift wing 126, and is arranged where the line 134 changes curvature from concave up to concave down, but the lift wing 126 is not limited to the inflection point 136 on the line 134. For example, any line arranged parallel to the outer profile of the lift wing 126 (e.g., a top surface of the lift wing 126 or a bottom surface of the lift wing 126) defines an inflection point. The inclusion of the inflection point 136 in the general shape and profile of the lift wing 126 provides an aerodynamically efficient transition from the lift wing 126 to the wing tail 112, which help reduce drag along the body 105 of the cutting blade 100. In some embodiments, an inflection point 136 is located in a vertical plane defined along the longitudinal axis of the cutting blade 100. In some embodiments, an inflection point 136 may be equidistant (or approximately equidistant) between projections of the cutting edge 116 and the trailing edge 111 on the cutting plane 120.

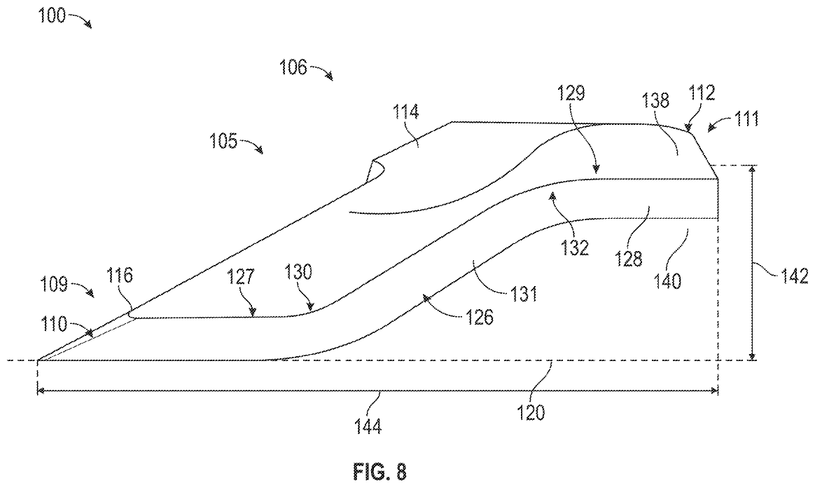

In some embodiments, the tail top surface 138 and a tail bottom surface 140, which is arranged on an opposing side of the wing tail 112, are substantially planar (see, e.g., FIG. 8). In some embodiments, the tail top surface 138 and/or the tail bottom surface 140 are not substantially planar, and may be at least partially arcuate, curved, or tapered (see, e.g., FIGS. 4 and 5). For example, the tail bottom surface 140 may taper (e.g., gradually decrease in height measured in a direction perpendicular to the cutting plane 120) as it extends toward the trailing edge 111, as shown in FIGS. 4 and 5. Specifically, the wing tail 112 includes a tapered surface or chamfer 135 and a stop or end surface 137. The tapered surface 135 extends between a trailing end of the tail bottom surface 140 and the end surface 137. In some embodiments, the tapered surface 135 defines a chamfer that is formed between faces defined by the tail bottom surface 140 and the end surface 137. In the illustrated embodiment, the tapered surface 135 tapers in a direction toward the tail top surface 138 as the tapered surface 135 extends toward the end surface 137. In other words, a height defined between a bottom edge of the tapered surface 135 and the tail top surface 138 (e.g., measured in a direction perpendicular to the cutting plane 120 and/or a direction parallel to the pivot axis 102) reduces as the tapered surface 135 extends toward the end surface 137. In some embodiments, the inclusion of the tapered surface 135 aids in further reducing the drag on the body 105 during operation of the cutting blade 100.

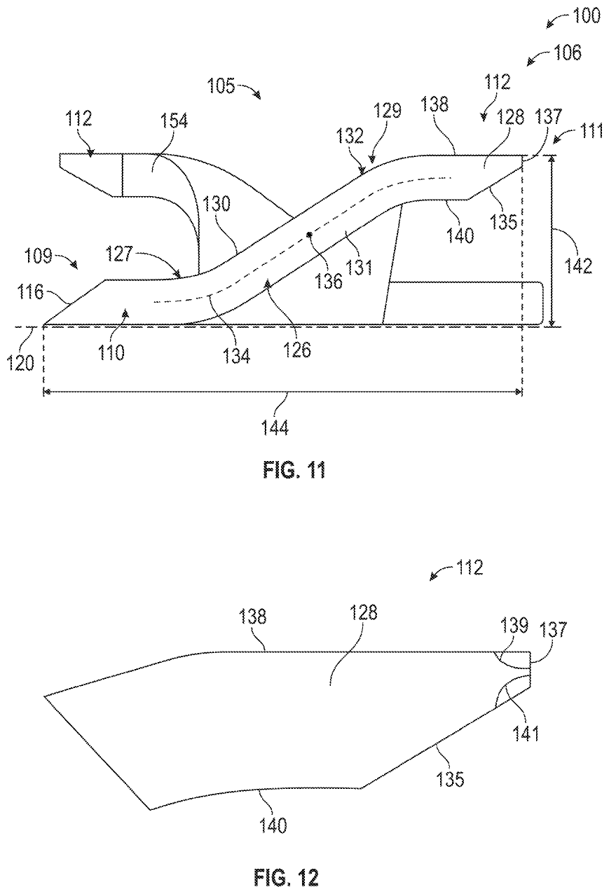

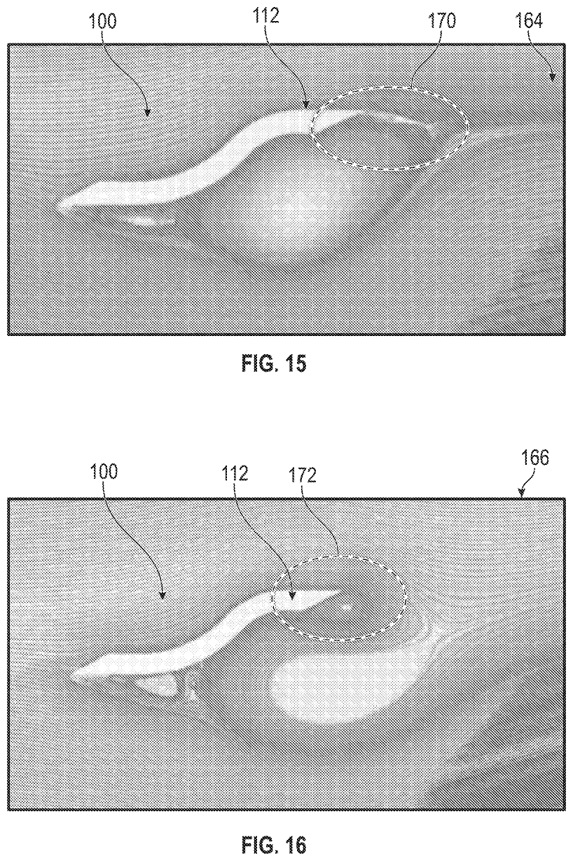

In the illustrated embodiment (and the embodiment of FIGS. 11-12), the tapered surface 135 is tapered so that the tapered surface 135 does not define a sharpened edge or point where the tapered surface 135 meets the tail top surface 138. In other words, the tapered surface 135 stops at the interface between the tapered surface 135 and the end surface 137, and the end surface 137 extends upwardly (e.g., from the perspective of FIGS. 4 and 5) toward the tail top surface 138 to define a flat that extends between the tapered surface 135 and the tail top surface 138. In this way, for example, the end surface 137 does not form an edge or line segment (e.g., similar to the cutting edge 116), and is planar and defines a height that extends in a direction perpendicular to the cutting plane 120 or parallel to the pivot axis 102. The non-sharpened geometry defined by the tapered surface 135 and the end surface 137 defines more than one interior angle between the tail top surface 138 and the tapered surface 135. For example, a first interior angle 139 is defined between the tail top surface 138 and the end surface 137, and a second interior angle 141 is defined between the end surface 137 and the tapered surface 135. In some embodiments, the first interior angle 139 is about ninety degrees (e.g., a right angle, or between about eighty-five degrees and about nintey-five degrees). In some embodiments, the second interior angle 141 is an obtuse angle (e.g., between about one hundred degrees and about one hundred and fifty degrees). The non-sharpened geometry defined by the trailing edge of the wing tail 112 (i.e., the falt defined by the end surface 137) provides a surprising and unexpected result of improved aerodynamic performance and reduced drag during operation, when compared to a wing tail having a sharpened tailing edge as discussed below with respect to FIGS. 15-18.

With continued reference to FIGS. 4A-5, a wing height 142 of the wing tail 112 is defined as a distance measured in a direction perpendicular to the cutting plane 120 between the cutting plane 120 and the tail top surface 138. In some embodiments, as shown in FIG. 4a, the wing height 142 is approximately 1 inch. In some embodiments, the wing height 142 is greater than 1 inch (e.g., approximately 1.1 inches, approximately 1.2 inches, approximately 1.35 inches, approximately 2 inches, etc.). In some embodiments, as shown in FIGS. 4B and 4C, the wing height 142 is less than approximately 1 inch, for example, approximately 0.75 inches as shown in FIG. 4B, or approximately 0.5 inches as showin in FIG. 4C. In general, the wing height 142 is correlated with an amount of lift generated during rotation of the rotary blade 100, with increasing the wing height 142 resulting in an increased amount of lift during operation. For example, an application requiring more lift may be designed to include a wing height 142 that is greater than an application requiring less lift.

As described herein, the wing tail 112 defines a protrusion or extension that extends from the trailing end 129 of the lift wing 126 to reduce drag on the body 105. Each of the arms 106 define a tail width 144 defined along a direction parallel to the cutting direction 115 between the leading edge 109 and the trailing edge 111. The extension defined by the wing tail 112 increases the width of the distal ends of the arms 106, for example, relative to a width defined at the arm body portion 114, shown as body width 148. That is, the tail width 144 is greater than the body width 148. In some embodiments, the tail width 144 is greater than a width of the body 105 measured at any location axially between the pivot aperture 104 and the wing tails 112. The increased width defined by the wing tails 112 extends the flow area over which air can flow and aids in maintaining laminar flow over the body 105, which reduces the drag on the body 105.

Turning to FIGS. 3A, 6 and 7, the wing tails 112 extend axially along the arms 106 of the body 105 a tail distance 146 (e.g., measured in a direction parallel to the longitudinal axis 108). In some embodiments, the tail distance 146 is between about 0.5 inches and about 6 inches, or between about 1 inches and about 5 inches, or between about 2 inches and about 4 inches, or between about 2.5 inches and about 3.5 inches. In some embodiments, a tail ratio between a radius 150 defined by the body 105 (e.g., a distance measured along the longitudinal axis 108 between the pivot axis 102 and a distal end of the arms 106) and the tail distance 146 is between about 21 and about 1.5, or between about 10.5 and about 1.5, or between about 7 and about 1.5, or between about 10.5 and about 2, or between about 7 and about 2, or between about 6 and about 2, or between about 6 and about 3, or between about 4.5 and about 3, or between about 4.5 and about 3.5. In general, the inclusion of the wing tail 112 on the cutting blade 100 reduces the drag along the body 105 and accordingly reduces the amount of input power required to rotate the cutting blade 100 (e.g., when compared to conventional cutting blades). In some embodiments, the tail ratio being between 10 and about 2, or preferably between about 6 and about 3, or more preferably between about 4.5 and about 3 provides the unexpected result of further reducing the amount of drag on the body 105 and the corresponding amount of input power required to rotate the cutting blade 100.

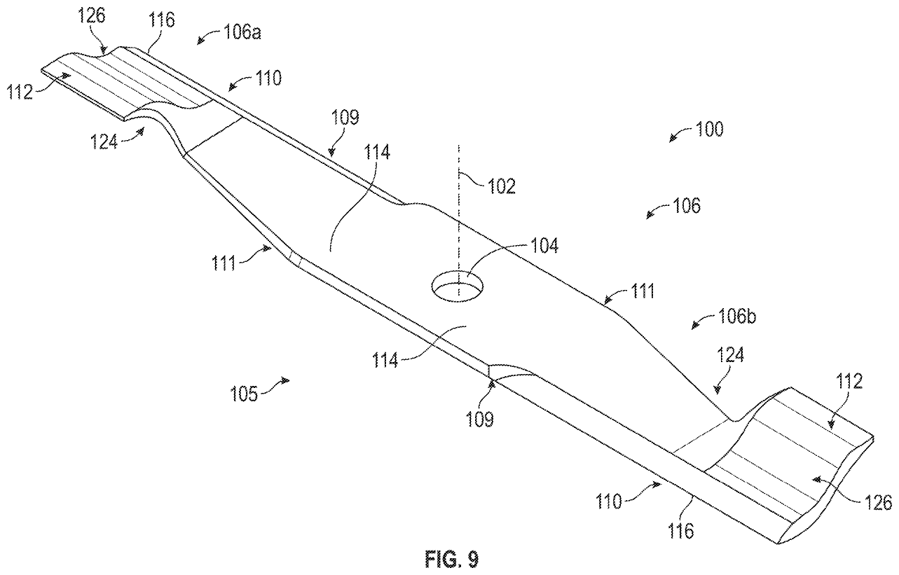

FIGS. 9-12 illustrate another embodiment of the rotary cutting blade 100. In general, the rotary cutting blade 100 of FIGS. 9-12 is similar to the rotary cutting blade 100 of FIGS. 3A-7, with like features identified using the same reference numerals, except as descirbed herein or apparent from the figures. As illustrated in FIGS. 9-12, the recessed portion 124 includes a tapered surface 152 and an arcuate or curved surface 154. The tapered surface 152 extends axially from the arm body portion 114 in a direction toward the wing tail 112. As the tapered surface 152 extends toward the wing tail 112, the tapered surface 152 tapers toward the longitudinal axis 108 so that a width of the arms 106a, 106b gradually decreases (e.g., measured in a direction perpendicular to the longitudinal axis 108). The tapered surface 152 extends from the body portion 114 to an interface between the tapered surface 152 and the curved surface 154. The curved surface 154 initially curves inwardly toward the longitudinal axis 108 and then outwardly away from the longitudinal axis 108 and to an interface between the curved surface 154 and the wing tail 112. The curved surface 154 also extends upwardly (e.g., in a direction genearlly parallel to the pivot axis 102) as it curves away from the longitudinal axis 108 (see, e.g., FIG. 11).

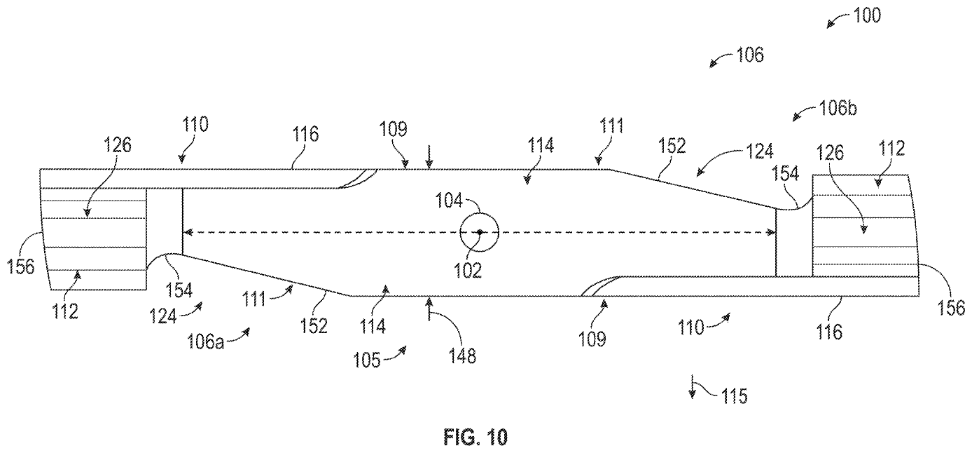

In the illustrated embodiment, each of the arms 106a, 106b includes a laterally-outer edge 156 that defines an arcuate or curved profile (see, e.g., FIG. 10). The curved proile defined by the laterally-outer edges 156 generally conforms with a circular cutting path defined during rotation of the cutting blade 100.

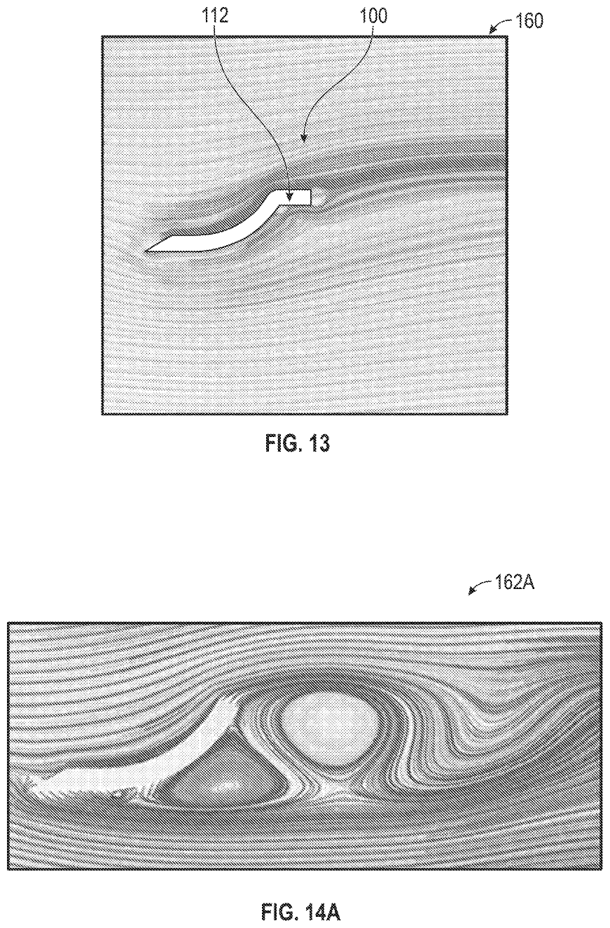

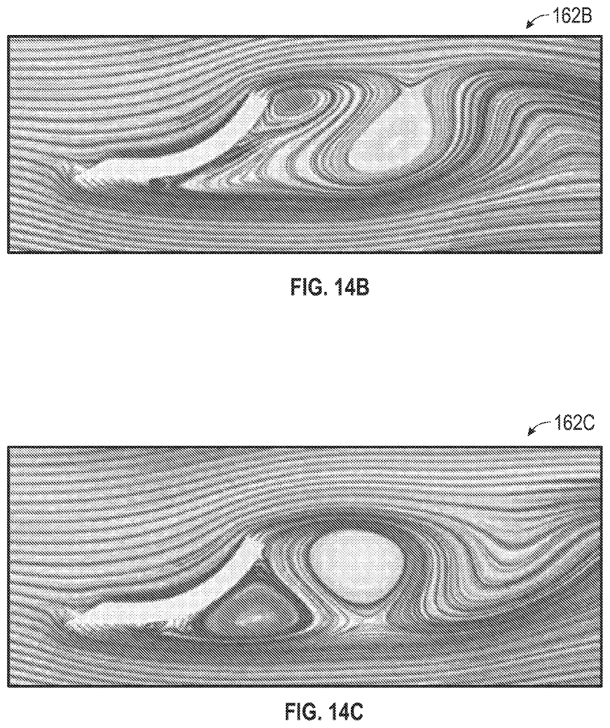

Referring to FIG. 13, a streamline plot 160 of a cross section of the cutting blade 100 taken through the wing tail 112, with the tail bottom surface 140 being non-tapered (FIG. 8), is shown. Referring to FIGS. 14A-14C, streamline plots 162A, 162B, and 162C, respectively, are shown of a cross section a conventional mower blade (i.e., no wing tail trailing from the lift wing) taken at different times during operation (with 162A occuring before 162B and 162B occuring before 162C). Streamlines (e.g., lines tangential to the instantaneous velocity direction) generated during a computational fluid dynamics (CFD) analysis extend from the left-hand side of the figure to the right-hand side of the figures, and illustrate the disruptions caused by blade profiles in the flow path. As shown in FIG. 14A, the conventional mower blade generates a significant amount of turbulence (e.g., eddies) behind the cutting blade and the flow separation (i.e., the streamlines separating from the outer surfaces of the blade) occurs in the front portion of the blade. As showin in FIGS. 14A-14C, the low pressure eddies formed behind the conventional mower blade occur continuously during operation and do not dampen out until well behind the conventional mower blade. Specifically, the eddies formed in FIG. 14A appear to initially break up in FIG. 14B but then reform in FIG. 14C, so the conventional mower blade continuously forms alternative or undulating low pressure eddies behind the blade during operation. These continuously forming low pressure eddies formed behind the conventional mower blade act to separate the streamlines flowing over the conventional blade increase the drag forces acing on the blade during rotation.

On the other hand, the cutting blade 100 shown in FIG. 13 provides a streamlined, generally laminar flow field (e.g., lower Reynolds number when compared to the convention blade of FIG. 14A-14C) over the cutting blade 100. That is, the flow separation is prevented or delayed to a back side of the blade, which substantially reduces or eliminates the turbulence generated by rotating the cutting blade 100 and lowers the drag forces acting on the cutting blade 100 during rotation.

Surprisnigly and unexpectedly, the cutting blade 100 including the wing tail 112 reduces drag forces, while maintaining a lifting force sufficient for performing secondary functions (e.g., lifting grass into the cutting plane 120 and blowing cut grass away from the cutting plane 120), as shown by the pressure gradients illustrated in FIG. 13 (i.e., pressure decreases in a direction moving from a bottom of the cutting blade 100 to a top of the cutting blade 100). Further, testing of the cutting blade 100 at a 3100 RPM rotational speed yielded unexpected and unconventional results consistent with the findings in FIG. 13. For example, the cutting blade 100 having a tail ratio of approximately 3 yielded a 30% reduction in input power required to rotate in air compared to conventional mower blades. Additionally, a test of the mower blade 100 having a tail ratio of approximately 4.2 unexpectedly yielded a 34% reduction in power required to rotate in air compared to conventional mower blades. Further, a test of the mower blade 100 having a tail ratio of approximately 4.2 and a tapered tail bottom surface 140 (see, e.g., FIGS. 4 and 11-12) unexpectedly yielded a 36% reduction in power required to rotate in air compared to conventional mower blades. Accordingly, the design of the cutting blade 100 including the wing tail 112 provides a significant (e.g., greater than 30%) reduction in input power required (e.g., output by an electric motor) to rotate the cutting blade 100 when compared to conventional blade designs. This enables a mower (e.g., the mower 10) that incorporates the cutting blade(s) 100 to operate for longer periods of time, for example, between battery charges, and/or to operate for the same amount of time using a smaller battery capacity when compared to conventional cutting blades. Additionally, a mower having an internal combusion engine may benefit from the lower drag provided by the cutting blade 100 and testing has shown that fuel economy savings of greater than about 25% may be observed when using the cutting blade 100 over a conventional cutting blade. Further, the cutting blade 100 including the wing tail 112 has been shown through testing to also reduce noise, for example, 1 dBA to 3 dBA reduction depending on blade size (length) and rotating speed.

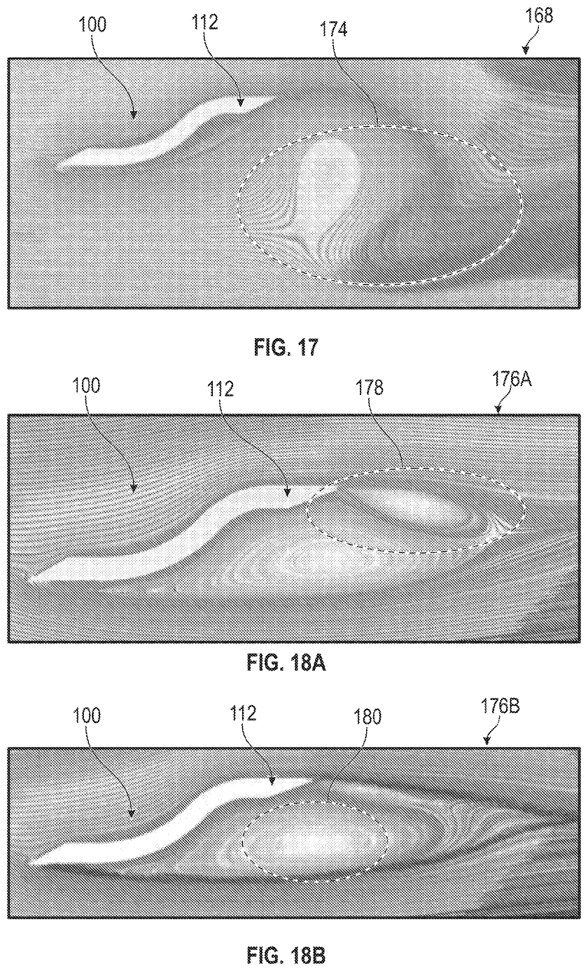

FIGS. 15-17 show streamline plots 164, 166, 168, respectively, for the cutting blade 100 including a sharpened wing tail, where the tapered surface 135 is sharpened to a point or edge. In general, the streamline plots 164, 166, and 168 are taken at different time interfals during operation of the cutting blade (with 164 occuring before 166 and 166 occuring before 168) in a CFD analysis. As illustrated in FIG. 15, the sharp edge at the trailing edge of the wing tail 112 initially creates flow separation at the sharpened edge, as shown in region 170. But the separation does not get large enough (as inidiated by the region 172 in FIG. 16) to maintian a large area of low pressure that trails behind the cutting blade 100. As a result, the flow separation sheds from the cutting blade 100 and creates a large downdraft behing the cutting blade 100 as initiated by region 174 in FIG. 17. The downdraft and lack of maintained flow separation behind the cutting blade 100 has a negative effect on performance (e.g., less lift and higher drag)

Surprisingly and unexpectedly, desgining the wing tail 112 to include a flat defined by the end surface 137, rather than sharpening the tapered surface 135, improves the aerodynamic performance of the cutting blade 100. For example, FIGS. 18A and 18B show streamline plots 176A and 176B, respectively, of the cutting blade 100 with the end surface 137 of FIGS. 4-5 and 11-12 that defines a flat or planar surface. The streamline plot 176A occurs at a different time than the streamline plot 176B, with 176A occuring before 176B. As shown in FIGS. 18A and 18B, the inclusion of the end surface 137 forms a stable low-pressure region formed behind the cutting blade 100 that creates an air-pressure-based airfoil that allows the streamlines to flow nearly laminarly around the cutting blade 100 and reconnet at region 178 with minimal flow separation behind the cutting blade 100. The flow separation is prevented from further shedding from the cutting blade 100 and the stable low-pressue region formed below the cutting blade 100 is maintained, as shown in region 180, and acts to lift the air following the cutting blade 100. The nealy laminar streamlines, minimal flow separation, and stable low-pressure region formed by the cutting blade 100 all improve the aerodynamic performance of the cutting blade 100 by reducing drag and increasing lift.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the cutting blade 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A rotary cutting blade for a lawn mower, the rotary cutting blade comprising:
a cutting edge;
a lift wing that arcs or angles upwardly from the cutting edge, wherein the lift wing defines a leading end from which the cutting edge extends and a trailing end; and
a wing tail that extends from the trailing end of the lift wing in a direction away from the cutting edge.

2. The rotary cutting blade of claim 1, wherein the cutting edge defines a cutting plane.

3. The rotary cutting blade of claim 2, wherein the wing tail extends from the trailing end of the lift wing at an angle that is approximately parallel to the cutting plane.

4. The rotary cutting blade of claim 1, wherein the lift wing defines an inflection point where a profile of the lift wing transitions from concave up to concave down.

5. The rotary cutting blade of claim 1, further comprising a body, wherein the wing tail extends axially along the body a tail distance.

6. The rotary cutting blade of claim 5, wherein a ratio between a radius defined by the body and the tail distance is between about 10 and about 2, or between about 6 and about 3, or between about 4.5 and about 3.

7. The rotary cutting blade of claim 1, wherein the wing tail includes a tail top surface, a tail bottom surface, a tapered surface, and an end surface, wherein the tapered surface extends between the tail bottom surface and the end surface.

8. The rotary cutting blade of claim 7, wherein the tapered surface tapers in a direction toward the tail top surface as the tapered surface extends in a direction from the tail bottom surface to the end surface.

9. The rotary cutting blade of claim 7, wherein the end surface defines a flat, non-sharpened surface at an interface between the tail top surface and the tapered surface.

10. The rotary cutting blade of claim 9, wherein the end surface defines a trailing edge of the wing tail.

11. The rotary cutting blade of claim 9, wherein a first interior angle is defined between the the tail top surface and the end surface and a second interior angle is defined between the end surface and the tapered surface.

12. The rotary cutting blade of claim 11, wherein the first interior angle is about ninety degrees.

13. The rotary cutting blade of claim 11, wherein the second interior angle is obtuse.

14. A rotary cutting blade for a lawn mower, the rotary cutting blade comprising:
a body including a cutting edge defining a cutting plane, a lift wing, and a wing tail, wherein a cross-sectional profile of the body taken along a direction parallel to a cutting direction and through the wing tail includes:
a cutting portion that extends in a direction parallel to the cutting plane;
a lift wing portion that angles or arcs upwardly away from the cutting plane; and
a tail portion that extends along the wing tail from a trailing end of the lift wing in a direction away from the cutting edge at an angle that is approximately parallel to the cutting plane.

15. The rotary cutting blade of claim 14, wherein the lift wing portion defines an inflection point where a profile of the lift wing portion transitions from concave up to concave down.

16. The rotary cutting blade of claim 14, wherein the wing tail extends axially along the body a tail distance.

17. The rotary cutting blade of claim 16, wherein a ratio between a radius defined by the body and the tail distance is between about 10 and about 2, or between about 6 and about 3, or between about 4.5 and about 3.

18. The rotary cutting blade of claim 14, wherein the wing tail includes a tail top surface, a tail bottom surface, a tapered surface, and an end surface, wherein the tapered surface extends between the tail bottom surface and the end surface.

19. (canceled)

20. The rotary cutting blade of claim 18, wherein the end surface defines a flat, non-sharpened surface at an interface between the tail top surface and the tapered surface.

21-24. (canceled)

25. A rotary cutting blade for a lawn mower, the rotary cutting blade comprising:
a body including a cutting edge, a lift wing, and a wing tail that extends from a trailing end of the lift wing in a direction away from the cutting edge,
wherein the lift wing is arranged between the cutting edge and the wing tail, and wherein the lift wing defines an inflection point along the body where the body transitions from concave up to concave down.

26-49. (canceled)
